(19) United States
(12) Patent Application Publication
(10) Pub. No.: US 2015/0367861 A1
(43) Pub. Date: Dec. 24, 2015

(54) VEHICLE-MOUNTED DEVICE, SERVER DEVICE AND TRAVEL STATE CONTROL METHOD

(71) Applicant: MITSUBISHI ELECTRIC CORPORATION, Chiyoda-ku, Tokyo (JP)

(72) Inventors: Yoshihiko MORI, Tokyo (JP); Takuji MORIMOTO, Tokyo (JP)

(73) Assignee: MITSUBISHI ELECTRIC CORPORATION, Tokyo (JP)

(21) Appl. No.: 14/766,950

(22) PCT Filed: May 16, 2013
(86) PCT No.: PCT/JP2013/063691

§ 371 Date: Aug. 10, 2015

(51) Int. Cl. B60W 50/14

(52) U.S. Cl. CPC B60W 50/14

(57) ABSTRACT

A vehicle-mounted device of the present invention has a vehicle information acquisition unit 14 that acquires vehicle information on the state of a vehicle, and a control unit 11 that executes an application accompanied by at least one of a visual output and an auditory output and based on the vehicle information acquired by the vehicle information acquisition unit 14, instructs a vehicle control unit 15 controlling the travel state of the vehicle to link the output of the application with the travel state of the vehicle.

### TECHNICAL FIELD

The present invention relates to a vehicle-mounted device equipped in, for example, a vehicle capable of automatic operation, a server device, and a travel state control method.

### BACKGROUND ART

Patent Document 1, for example, discloses a navigation device that executes a vehicle-linked application while using a detection result of the travel state of a vehicle. The navigation device changes the movement of a character during display in accordance with, for example, the speed of the vehicle. If the character during display is a fish in a tank of an aquarium application, how the fish swims is changed in accordance with the travel state of the vehicle. This enables an occupant of the vehicle to intuitively grasp the travel state of the vehicle. Additionally, in Patent Document 1, as various information indicating the travel state of the vehicle, the direction, altitude, and presence/absence of light turning on are prescribed in addition to the travel speed of the vehicle, and the movements of the character are changed in accordance with these pieces of information.

### CITATION LIST

### Patent Document

Patent Document 1: Japanese Patent Application Laid-open No. 2004-301546

### SUMMARY OF THE INVENTION

### Problems to be Solved by the Invention

In the prior art represented by Patent Document 1, the display content of the vehicle-linked application is merely linked with the travel state of the vehicle. In other words, even when a user intuitively grasps the travel state of the vehicle from the display content of the vehicle-linked application, a drive operation different from the vehicle-linked application is necessary in order to actually change the travel state of the vehicle. For example, when an automatic operation mode in which the drive operation is automatically performed is set, it is more convenient for the user to be able to intuitively grasp the travel state of the vehicle from the display content of the vehicle-linked application, and to change the travel state of the vehicle through an operation to that display content.

The present invention is made to solve the foregoing problems and an object thereof is to obtain a vehicle-mounted device, a server device, and a travel state control method that enable the user to intuitively grasp the travel state of the vehicle and easily change the travel state of the vehicle to a desired travel state.

### Means for Solving the Problems

A vehicle-mounted device of the present invention includes: a vehicle information acquirer that acquires vehicle information on the state of a vehicle; and a controller that executes an application accompanied by at least one of a visual output and an auditory output, and that based on the vehicle information acquired by the vehicle information acquirer, instructs a vehicle controller that controls the travel state of the vehicle to link the output of the application with the travel state of the vehicle.

### Effect of the Invention

According to the invention, there is an advantageous effect of enabling a user to intuitively grasp the travel state of the vehicle and to easily change the travel state of the vehicle to a desired travel state.

### BRIEF DESCRIPTION OF THE DRAWINGS

FIG. 1 is a block diagram showing a configuration of a travel state control system of the present invention.

FIG. 2 is a sequence chart showing a travel state control method according to Embodiment 1.

FIG. 3 is a flowchart showing the travel state control method according to Embodiment 1.

FIG. 4 is a diagram showing an example of a vehicle-linked application according to Embodiment 1.

FIG. 5 is a flowchart showing availability determination for vehicle control (Part 1) according to Embodiment 1.

FIG. 6 is a flowchart showing availability determination for vehicle control (Part 2) according to Embodiment 1.

FIG. 7 is a flowchart showing a travel state control method according to Embodiment 2 of the invention.

FIG. 8 is a diagram showing an example of an output of a vehicle-linked application according to Embodiment 2 and a user operation thereto.

FIG. 9 is a flowchart showing a travel state control method according to Embodiment 3 of the invention.

FIG. 10 is a diagram showing a configuration of a travel state control system according to Embodiment 4 of the invention.

### MODES FOR CARRYING OUT THE INVENTION

Hereinafter, in order to describe the present invention in more detail, modes for carrying out the present invention are described with reference to the accompanying drawings.

### Embodiment 1

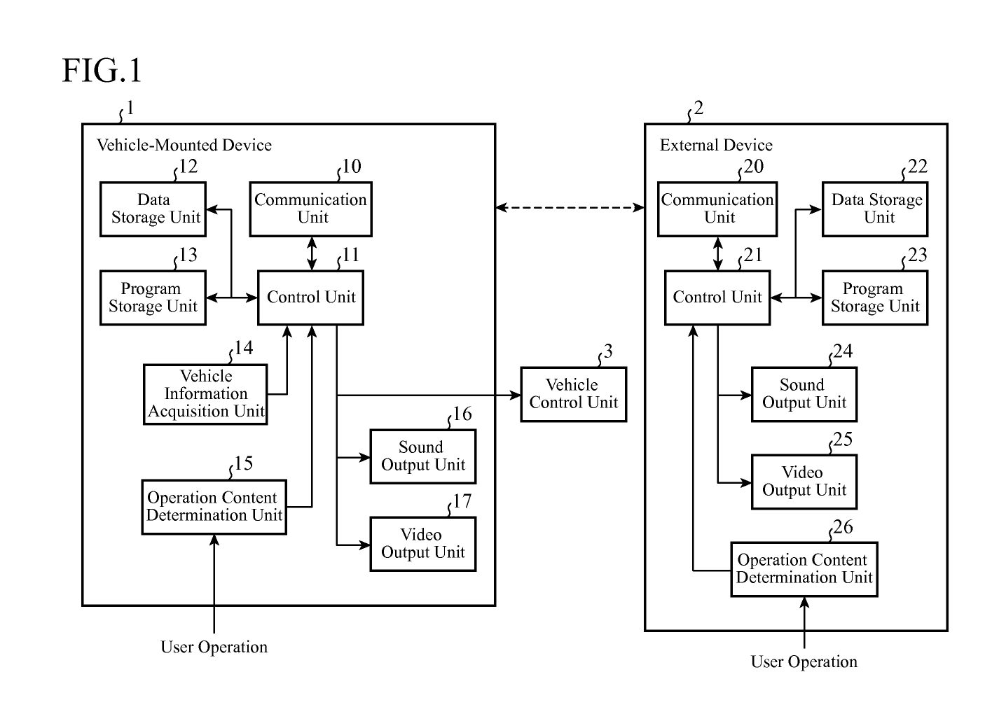

FIG. 1 is a block diagram showing a configuration of a travel state control system of the present invention. The travel state control system shown in FIG. 1 is equipped in a vehicle to control the travel state of the vehicle. Additionally, the vehicle equipped with the system is the one capable of switching between a manual operation mode to be run by a drive operation of a driver and an automatic operation mode to be run under the drive operation automatically performed. Note that the automatic operation mode includes, for example, inter-vehicle distance control that controls the travel speed and the like so that the vehicle runs to keep a predetermined distance with the preceding vehicle.

In addition, the travel state control system is configured with a vehicle-mounted device 1, an external device 2, and a vehicle control unit 3 as shown in FIG. 1.

The vehicle-mounted device 1 includes, for example, a navigation device equipped in the vehicle, a navigation and audio integrated system provided integrally with the navigation device and an audio device, and so on.

The external device 2 is a portable device that can be carried into the vehicle by an occupant, and includes, for example, a smartphone, a tablet PC, a portable navigation device, and so on.

As shown in FIG. 1, the vehicle-mounted device 1 is configured with a communication unit 10, a control unit 11, a data storage unit 12, a program storage unit 13, a vehicle information acquisition unit 14, an operation content determination unit 15, a sound output unit 16, and a video output unit 17. The communication unit 10 performs communication via wired or wireless connection to the external device 2, and is a communication unit that performs wireless communication such as Bluetooth (trade mark: description thereof will be hereinafter omitted) or Wi-Fi.

The control unit 11 executes an application accompanied by at least one of a visual output and an auditory output (referred to as “vehicle-linked application,” hereinafter), and instructs the vehicle control unit 3 to link the output content of the vehicle-linked application with the travel state of the vehicle, based on the vehicle information acquired by the vehicle information acquisition unit 14.

Additionally, the vehicle-linked application executed by the control unit 11 is the one that outputs a processing result to at least one of the sound output unit 16 and the video output unit 17, and may be an existing player application for reproducing music as well as an application that is newly created to be linked with the travel state of the vehicle.

The data storage unit 12 is a storage unit for storing data used by the control unit 11 in order to execute the vehicle-linked application, or data generated when the control unit 11 executes the vehicle-linked application. It is realized by, for example, a ROM (Read Only Memory) or a RAM (Random Access Memory).

In addition, the communication unit 10 stores, in the data storage unit 12, map data of the position of the vehicle downloaded from an external site (map data server device) and its surroundings, based on the current position of the vehicle that is acquired as vehicle information by the vehicle information acquisition unit 14. In this manner, the data storage unit 12 functions as a buffer for temporarily storing the data.

The program storage unit 13 is a storage unit for storing a program that is executed by the control unit 11, and functioned as the vehicle-mounted device 1 of the invention. Examples of the program stored in the program storage unit 13 includes a program for communicating with the external device 2, a program for authenticating the external device 2 to be connected therewith, and a program for causing the vehicle control unit 3 to perform a desired control.

The vehicle information acquisition unit 14 is a vehicle information acquisition unit for acquiring the vehicle information related to the state of the vehicle. The vehicle information is the information that indicates the states of the vehicle itself, the inside of the vehicle, and the surroundings of the vehicle as the states of the vehicle, and specified by, for example, vehicle speed, rotation amount of engine, remaining amount of driving energy such as fuel, and conditions inside and outside the vehicle that are determined by analysis of an image captured by an in-vehicle camera.

The operation content determination unit 15 determines the content of a user operation to the output of the vehicle-linked application being executed by the control unit 11. For instance, it receives a touch operation onto a touch panel, and determines a type of operation to the content displayed by the video output unit 17 (tapping operation, dragging operation, flicking operation, etc.). In addition, it may determine which hardware key is pressed and operated, or may determine a result in which a user's speech indicating the operation is voice recognized. For example, the operation content determination unit 15 recognizes the user's speech such as “slowly” or “in haste” as an output content of the vehicle-linked application and the operation for slowing down or hasting the travel state of the vehicle.

The sound output unit 16 is a device composed of an amplifier and a speaker for outputting sound data such as music, and operates in response to a command from the control unit 11.

The video output unit 17 is a monitor device for outputting a moving image data such as a video, and operates in response to a command from the control unit 11.

As shown in FIG. 1, the external device 2 is configured with a communication unit 20, a control unit 21, a data storage unit 22, a program storage unit 23, a sound output unit 24, a video output unit 25, and an operation content determination unit 26. The communication unit 20, control unit 21, data storage unit 22, program storage unit 23, sound output unit 24, video output unit 25, and operation content determination unit 26 in the external device 2 are operated in the same manner as the communication unit 10, control unit 11, data storage unit 12, program storage unit 13, sound output unit 16, video output unit 17, and operation content determination unit 15 in the vehicle-mounted device 1.

In the travel state control system shown in FIG. 1, the vehicle-mounted device 1 alone is capable of instructing the vehicle control unit 3 to link the output content of the vehicle-linked application with the travel state of the vehicle. In addition, when the external device 2 executes the vehicle-linked application, generates a control signal for linking the output content of the vehicle-linked application with the travel state of the vehicle based on the vehicle information received from the vehicle-mounted device 1, and transmits the control signal to the vehicle-mounted device 1, the vehicle-mounted device 1 can instruct the vehicle control unit 3 to that effect based on the control signal to link the output of the vehicle-linked application with the travel state of the vehicle.

The vehicle control unit 3 is equipped in the vehicle, controls the travel state of the vehicle in accordance with the instruction from the control unit 11 (or 21). For instance, it controls acceleration, deceleration, and turning of the vehicle in accordance with the drive operation, and performs control of the travel state in the automatic operation mode. The contents of control are as follows: for example, control of parts of the vehicle (motor, tire angle regulator, etc.) related to the travel of the vehicle (speed adjustment, stop, direction change, etc.), and operation control of movable parts of the vehicle (wiper, blinker, window, seat, mirror, etc.).

Note that the communication unit 10, control unit 11, vehicle information acquisition unit 14, operation content determination unit 15, sound output unit 16, and video output unit 17 are realized as concrete cooperation means of hardware and software when a microcomputer configuring the vehicle-mounted device 1 executes a program related to processing unique to the invention.

In addition, the communication unit 20, control unit 21, data storage unit 22, program storage unit 23, sound output unit 24, video output unit 25, and operation content determination unit 26 are realized as the concrete cooperation means of the hardware and software when a microcomputer configuring the external device 2 executes the program related to the processing unique to the invention.

Next, an operation will be described.

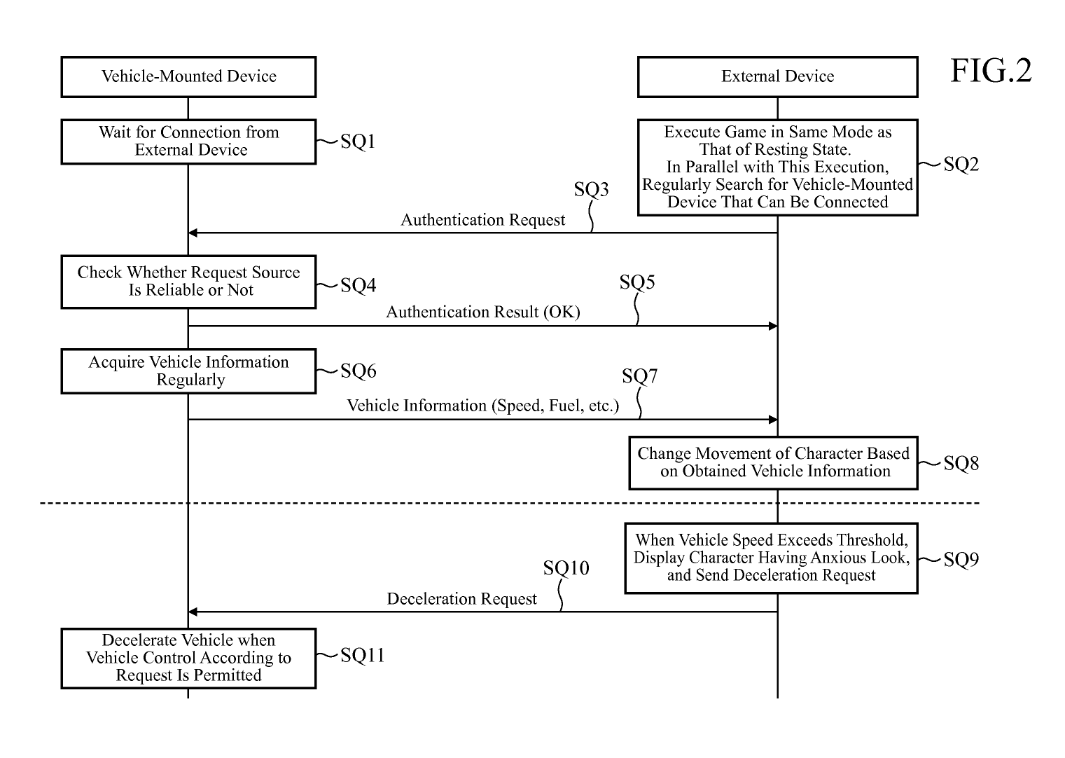

FIG. 2 is a sequence chart showing a travel state control method according to Embodiment 1.

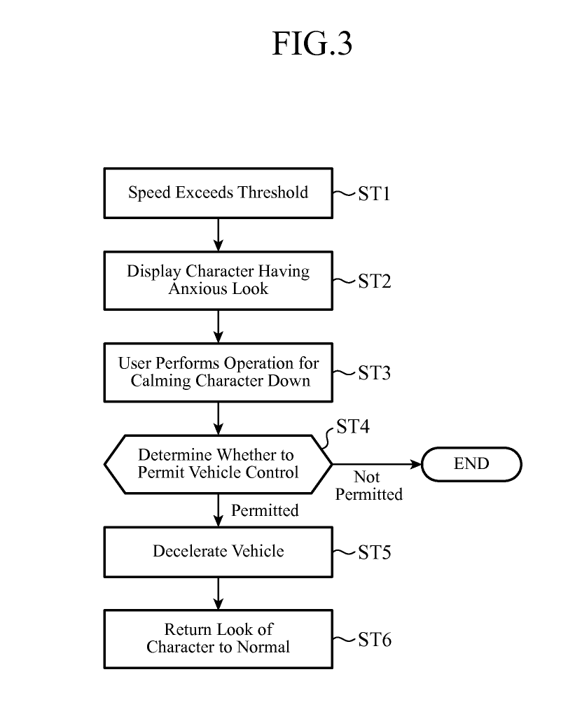

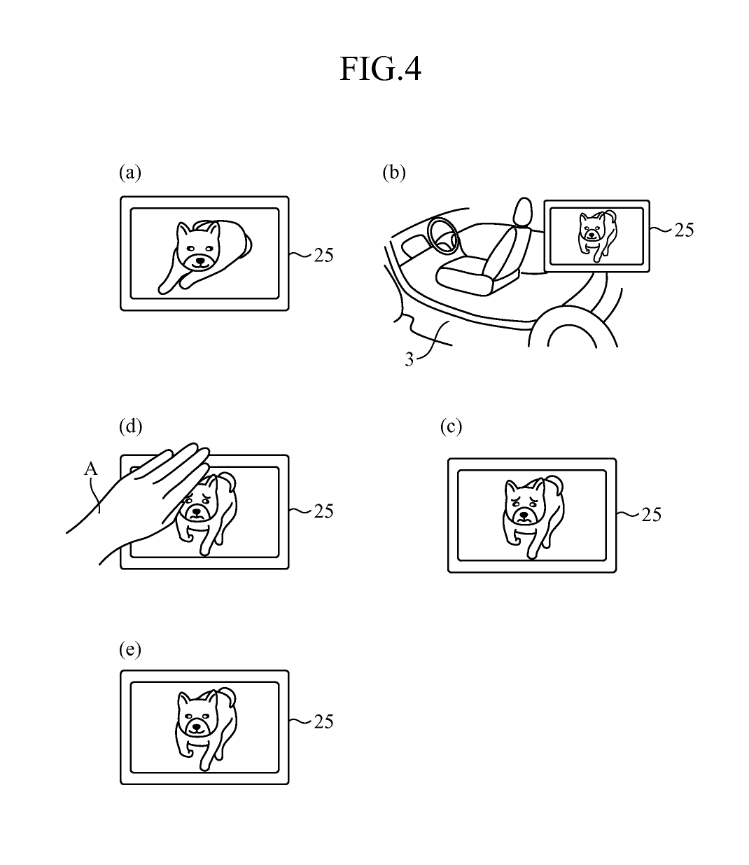

In addition, FIG. 3 is a flowchart of the travel state control method according to Embodiment 1, showing the processing below a broken line of FIG. 2. FIG. 4 is a diagram showing an example of the vehicle-linked application according to Embodiment 1.

In the following, there is described as an example a case in which the control unit 21 of the external device 2 executes the vehicle-linked application displaying an image of a dog character on the screen of the video output unit 25, and the vehicle-mounted device 1 instructs the vehicle control unit 3 to link the output of the vehicle-linked application with the travel state of the vehicle based on the control signal from the external device 2.

First of all, in prerequisite sequence SQ1, the communication unit 10 of the vehicle-mounted device 1 waits for communication connection from the communication unit 20 of the external device 2.

In sequence SQ2, the control unit 21 of the external device 2 executes the vehicle-linked application displaying an image of the dog character on the screen of the video output unit 25.

At this time, the vehicle information indicating the state of the vehicle is not input to the external device 2, and a video of the dog sitting and resting, for example, is displayed on the screen of the video output unit 25, as shown in FIG. 4(a). This corresponds to a situation where the user brings the external device 2 in a living room of his/her home and so on, and executes the vehicle-linked application.

In addition, in parallel with the above execution of the vehicle-linked application, the communication unit 20 of the external device 2 regularly searches for the vehicle-mounted device 1 that can be communicated and connected.

When the external device 2 is carried into the vehicle equipped with the vehicle-mounted device 1, the communication unit 20 of the external device 2 transmits an authentication request to the vehicle-mounted device 1 (sequence SQ3).

Based on the authentication request received by the communication unit 10 from the external device 2, the control unit 11 of the vehicle-mounted device 1 checks whether the external device 2 of a request source is reliable or not (whether or not to be an external device registered in the travel state control system of the invention) (sequence SQ4). For example, a situation can be considered in which an authentication ID of the external device 2 is stored beforehand in the data storage unit 12 and the control unit 11 conducts authentication by collating the ID contained in the authentication request of the external device 2 with the authentication ID stored in the data storage unit 12.

When it is determined that the external device 2 is a previously registered device (OK), the control unit 11 returns that effect to the external device 2 as an authentication result (sequence SQ5). As a result, the communication and connection between the communication unit 10 of the vehicle-mounted device 1 and the communication unit 20 of the external device 2 is established.

In sequence SQ6, the vehicle information acquisition unit of the vehicle-mounted device 1 acquires the vehicle information regularly. The vehicle information acquired by the vehicle information acquisition unit 14 is transmitted regularly to the external device 2 by the communication unit 10 (sequence SQ7).

Based on the vehicle information received by the communication unit 20, the control unit 21 of the external device 2 changes the output content of the vehicle-linked application (sequence SQ8). For example, when the vehicle is running, a video of the dog character running according to this is displayed on the screen of the video output unit 25, as shown in FIG. 4(b). By visually recognizing the screen, the user can intuitively grasp the travel state of the vehicle. In other words, it is displayed such that the running speed of the dog character increases as the vehicle speed contained in the vehicle information increases, and that the running speed of the dog character decreases as the vehicle decelerates.

Additionally, in a method for controlling the character with the vehicle-linked application, for example, with respect to a coordinate parameter for determining the position of the character in a virtual three-dimensional space, the control unit calculates a coordinate parameter of the next existing position of the character by using a speed parameter acquired as the vehicle information and elapsed time information being counted in a software service, By using a parameter that projects that position and the virtual three-dimensional space into a two-dimensional space, the control unit 21 determines the final shape and rendering position of a graphic object.

In addition, an animation to be rendered in accordance with a speed value notified as the vehicle information may be determined using animation data corresponding to a predetermined vehicle speed.

Next, a case in which the vehicle equipped with the vehicle-mounted device 1 is set in the automatic operation mode is taken into consideration.

The automatic operation mode is an operation mode in which the vehicle control unit 3 automatically controls the travel speed in such a manner that the vehicle travels while keeping a predetermined distance with the preceding vehicle, and assumes that a manually operated vehicle is mixed on the road in which the vehicle runs in addition to the automatically operated vehicle.

In this case, when the preceding vehicle changes the lane, and disappears from the front of the vehicle, the vehicle control unit 3 automatically increases the travel speed to be a predetermined interval in the inter-vehicle distance with the further preceding vehicle. At this time, there is a case in which the occupant of the own vehicle does not want an unnecessary speed increase.

Therefore, in a case where a speed threshold (allowable upper limit) in the inter-vehicle distance of the automatic operation is stored beforehand, when the speed of the vehicle exceeds the threshold, the control unit 21 changes the output content of the vehicle-linked application accordingly.

For example, the running dog character is changed to have an “anxious look,” as shown in FIG. 4(c), and displayed in the video output unit 25.

Note that the threshold is a value determined uniquely according to a road type, a road width, and a regulated speed; the smallest value out of the upper limit speeds that are set in these respective parameters is determined as the threshold.

Subsequently, the operation content determination unit 26 accepts an operation from the user referring to the screen of the video output unit 25, and determines the type of that operation. For example, as shown in FIG. 4(d), when the following operation is performed: an operation (dragging operation) in which a user A touches the touch panel prepared on the screen of the video output unit 25 and traces with his/her finger, namely such an operation as will calm the dog character that runs nervously, it is determined as an operation for a deceleration request.

When the content of the user operation determined by the operation content determination unit 26 makes a request for deceleration of the vehicle, the control unit 21 notifies the vehicle-mounted device 1 of the deceleration request (including the control signal for decelerating the vehicle by a predetermined variation) through the communication unit 20. The above corresponds to the processing of sequences SQ9 and SQ10.

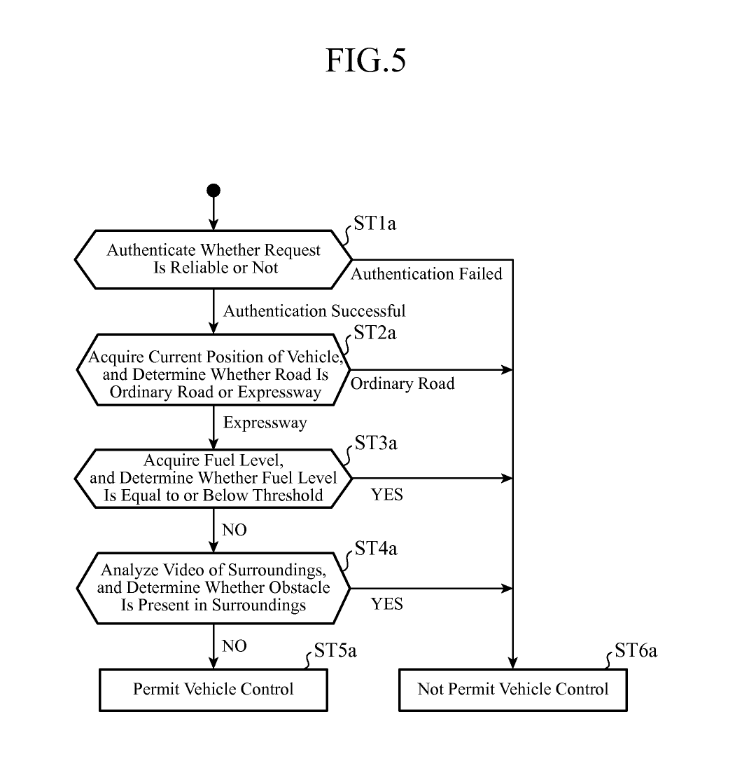

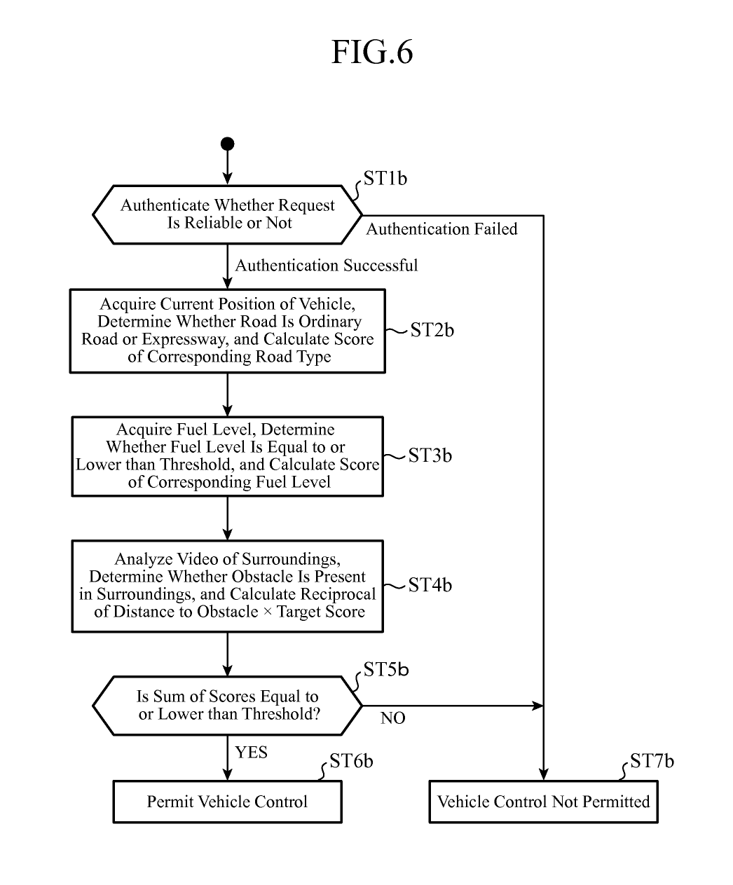

The control unit 11 of the vehicle-mounted device 1 determines whether to permit the vehicle control in accordance with the deceleration request received by the communication unit 10. The details of that determination are described later with reference to FIGS. 5 and 6. Here, in a case where the vehicle control is permitted, the control unit 11 instructs the vehicle control unit 3 to decelerate the vehicle (sequence SQ11). A deceleration method decelerates the vehicle to a predetermined speed or by a predetermined rate.

On the other hand, the control unit 21 of the external device 2 changes the output content of the vehicle-linked application according to the decelerated vehicle speed that is indicated by the vehicle information received by the communication unit 20.

For example, as shown in FIG. 4(e), the look of the running dog character is changed to an original look, and then displayed in the video output unit 25.

As mentioned above, in the invention, the travel state of the vehicle can be changed by the operation to the output of the vehicle-linked application that enables the user to intuitively grasp the travel state of the vehicle from the output content. In this manner, it can easily be changed to a desired travel state in the automatic operation mode without performing an operation different from that of the vehicle-linked application.

Incidentally, in FIG. 4, the “dog character running” video is displayed as the visual output; however, in place of this, “dog's footsteps” may be output as the auditory output, or the “dog's footsteps” may be output in accordance with the “dog character running” video.

Besides, actions of the dog character going up and down the slope may be displayed using the angle of inclination of the travel road of the vehicle acquired as the vehicle information,

Next, the processing of sequence SQ9 to sequence SQ11 is described in detail with reference to FIG. 3.

When the control unit 21 of the external device 2 determines based on the vehicle information received from the vehicle-mounted device 1 via the communication unit 20 that the vehicle speed exceeds a predetermined threshold (step ST1), the control unit 21 changes the look of the dog character to the “anxious look” and displays it in the video output unit 25, as shown in FIG. 4(c) (step ST2).

Thereafter, the operation content determination unit 26 accepts an operation from the user referring to the screen of the video output unit 25, and determines the type of that operation.

Here, when the “operation for calming the dog character” is performed on the touch panel of the video output unit 25 as shown in FIG. 4(d) (step ST3), the operation content determination unit 26 determines that that operation is for the deceleration request. When the content of the user operation determined by the operation content determination unit 26 makes a request for deceleration of the vehicle, the control unit 21 notifies the vehicle-mounted device 1 of the deceleration request (including the control signal for decelerating the vehicle by a predetermined variation) through the communication unit 20.

The control unit 11 of the vehicle-mounted device 1 determines whether to permit the vehicle control according to the deceleration request received by the communication unit 10 (step ST4). Here, in a case where the vehicle control is not permitted (step ST4; not permitted), the processing is ended. On the other hand, in a case where the vehicle control is permitted (step ST4; permitted), the control unit 11 instructs the vehicle control unit 3 to decelerate the vehicle (step ST5).

According to the decelerated vehicle speed that is included in the vehicle information received by the communication unit 20, the control unit 21 of the external device 2 changes the look of the running dog character to the original look (normal look) and displays it in the video output unit 25, as shown in FIG. 4(e) (step ST6).

Next, the details of vehicle control availability determination will be described.

FIG. 5 is a flowchart of vehicle control availability determination (Part 1) according to Embodiment 1, showing a detailed flow of the vehicle control availability determination at step ST4 in FIG. 3.

When there is a deceleration request from the external device 2, the control unit 11 of the vehicle-mounted device 1 authenticates whether that request is reliable or not (step ST1a). For example, an authentication ID unique to the external device 2 is stored beforehand in the data storage unit 12, and then the control unit 11 conducts authentication by collating the ID contained in the deceleration request of the external device 2 with the authentication ID stored in the data storage unit 12.

Here, in a case where the authentication is failed (step ST1a; authentication failed), the control unit 11 does not permit the vehicle control according to the deceleration request of the external device 2 (step ST6a).

On the other hand, in a case where the authentication is successful (step ST1a; authentication successful), the control unit 11 determines whether the road on which the vehicle is currently during travel is an ordinary road or an expressway, based on the current position of the vehicle acquired as the vehicle information by the vehicle information acquisition unit 14 and the map data stored in the data storage unit 12 (step ST2a).

Here, in a case where the vehicle travels on the ordinary road (step ST2a; ordinary road), the control unit 11 proceeds to the processing of step ST6a.

In a case where the vehicle is traveling on the expressway (step ST2a; expressway), the control unit 11 is inputted by the fuel level of the vehicle that is acquired as the vehicle information by the vehicle information acquisition unit 14, and determines whether that fuel level is equal to or lower than a predetermined threshold (step ST3a).

Here, in a case where the fuel level of the vehicle is equal to or lower than the threshold (step ST3a; YES), the control unit 11 proceeds to the processing of step ST6a. In a case where the fuel level is equal to or lower than the threshold, when the travel state of the vehicle is controlled in accordance with the output content of the vehicle-linked application, there is a possibility such that the fuel necessary for the travel becomes insufficient. For this reason, when the fuel level is equal to or lower than the threshold, the vehicle control is not permitted. Besides, in a case where the vehicle is an electric vehicle, the remaining battery level is used in place of the fuel level.

In a case where the fuel level exceeds the threshold (step ST3a; NO), the control unit 11 is inputted by a video of the surroundings of the vehicle that is acquired as the vehicle information by the vehicle information acquisition unit 14, analyzes the video, and determines whether an obstacle is present around the vehicle (step ST4a).

Here, in a case where the obstacle is present around the vehicle (step ST4a; YES), the control unit 11 proceeds to the processing of step ST6a.

On the other hand, in a case where there are no obstacles around the vehicle (step ST4a; NO), the control unit 11 permits the vehicle control in accordance with the deceleration request of the external device 2 (step ST5a).

Note that the determinations from step ST2a to step ST4a are executed repeatedly even after the vehicle control is permitted at step ST5a.

The vehicle control availability determination may also be carried out as follows.

FIG. 6 is a flowchart showing vehicle control availability determination (Part 2) according to Embodiment 1. First of all, when there is the deceleration request from the external device 2, the control unit 11 of the vehicle-mounted device 1 authenticates whether that request is reliable or not, in the same manner as that of FIG. 5 (step ST1b). Here, when the authentication is failed (step ST1b; authentication failed), the control unit 11 does not permit the vehicle control according to the deceleration request of the external device 2 (step ST7b).

In a case where the authentication is successful (step ST1b; authentication successful), the control unit 11 determines whether the road on which the vehicle is currently during travel is the ordinary road or expressway, based on the current position of the vehicle acquired as the vehicle information by the vehicle information acquisition unit 14 and the map data stored in the data storage unit 12, and calculates a score of the corresponding road type (step ST2b).

For example, when a fixed value that is defined beforehand for each of the road types such as the ordinary road and expressway is used as a reference, the reference value is increased at a predetermined rate according to the road width and the number of lanes of the traveling road to be obtained as the score. The calculated score for the road type is stored in the data storage unit 12.

Next, the control unit 11 is inputted by the fuel level of the vehicle that is acquired as the vehicle information by the vehicle information acquisition unit 14, determines whether that fuel level is equal to or lower than a predetermined threshold, and calculates a score of the corresponding fuel level (step ST3b). For example, when a case in which the fuel level is equivalent to the above threshold is used as a reference, a reference value (fixed value) is defined beforehand with respect to the fuel level at that time. The control unit 11 calculates a fuel utilization rate of the vehicle by using current fuel consumption per unit time, increases the reference value at a predetermined rate in such a manner that as the fuel utilization rate is higher, it is a value higher than the reference value, to be obtained as the score. The calculated score for the fuel level is stored in the data storage unit 12.

Subsequently, the control unit 11 analyzes the video of the surroundings of the vehicle that is acquired as the vehicle information by the vehicle information acquisition unit 14, and determines whether or not the obstacle is present around the vehicle. In a case where the obstacle is present, the control unit 11 multiplies the reciprocal of the distance between the obstacle and the vehicle by a target score (step ST4b).

Here, the distance between the obstacle and the vehicle is determined through image recognition of the video of the surroundings of the vehicle.

In addition, the target score is a fixed value that is defined beforehand with respect to the type of the obstacle; for example, a value that multiplies each of the values corresponding to a pedestrian, a vehicle, a guardrail and the like by the reciprocal of the distance between the obstacle and the vehicle is obtained as the score. The calculated score related to the presence/absence of the obstacle is stored in the data storage unit 12.

Thereafter, the control unit 11 reads from the data storage unit 12 the score related to the road type, the score related to the fuel level, and the score related to the presence/absence of the obstacle that are calculated in the foregoing processing, calculates the sum of the above scores, and determines whether the sum of the scores is equal to or lower than a predetermined threshold (step ST5b). Note that the scores are set to increase as the vehicle is further away from a normal (safe) state when the vehicle control according to the output of the vehicle-linked application is performed. For this reason, the threshold related to the sum of the scores is the upper limit of the sum of the scores that permits the vehicle control.

Thus, in a case where the sum of the scores is not equal to or lower than the above threshold, or exceeds the threshold (step ST5b; NO), the control unit 11 does not permit the vehicle control in accordance with the deceleration request from the external device 2 (step ST7b).

On the other hand, in a case where the sum of the scores is equal to or lower than the threshold (step ST5b; YES), the control unit 11 permits the vehicle control according to the deceleration request from the external device 2 (step ST6b).

The processing from step ST2b to step ST5b are executed repeatedly even after the vehicle control is permitted at step ST6b.

In FIG. 4, the application for displaying the dog character is taken as the vehicle-linked application; however, the application for displaying the dog character may be the one accompanied by at least one of the visual output and auditory output, or may be, for example, an application for displaying a running race car.

Note that although the case of matching the output content of the vehicle-linked application with the travel state of the vehicle is illustrated, the travel state of the vehicle may be controlled to be matched with the output content of the vehicle-linked application. For instance, when the vehicle-linked application that moves the character in predetermined rhythm and tempo is carried out, the vehicle speed in the automatic operation mode can be increased or reduced by a predetermined variation in accordance with the rhythm and tempo.

When the user selects appropriately the vehicle-linked application that provides different rhythm and tempo in the movement of the character, it is possible to change easily the travel state of the vehicle with the rhythm and tempo desired by the user in the automatic operation mode.

Note that in this case, the operation content determination unit may be omitted because the travel state of the vehicle can be controlled without reception of the user operation.

As described above, according to Embodiment 1, there is provided with: the vehicle information acquisition unit 14 that acquires the vehicle information on the state of the vehicle; and the control unit 21 (or 11) that executes the vehicle-linked application accompanied by at least one of the visual output and auditory output, and instructs the vehicle control unit 3 that controls the travel state of the vehicle to link the output of the vehicle-linked application with the travel state of the vehicle, based on the vehicle information acquired by the vehicle information acquisition unit 14.

This configuration can help to intuitively grasp the travel state of the vehicle from the output content of the vehicle-linked application.

In addition, the travel state can easily be changed to a desired travel state when a desired vehicle-linked application is selected or the output content is changed through the operation to the vehicle-linked application.

In addition, according to Embodiment 1, there is provided with the operation content determination unit 15 that determines the content of the operation to the outputs of the vehicle-linked application, and the control unit 21 (or 11) changes the output of the vehicle-linked application and the travel state of the vehicle in linkage with each other in accordance with the content of the operation determined by the operation content determination unit 15. In such a way, the output of the vehicle-linked application and the travel state of the vehicle can easily be changed to desired states in accordance with the user operation.

Further, according to Embodiment 1, because the control unit 21 (or 11) links the movement of the character displayed by the vehicle-linked application with the travel state of the vehicle, the travel state of the vehicle can easily be grasped intuitively from the output content of the vehicle-linked application.

Furthermore, according to Embodiment 1, the control unit 21 (or 11) determines whether or not to link the output of the vehicle-linked application with the travel state of the vehicle based on at least one of the type of the road on which the vehicle is traveling, the fuel level (remaining amount of driving energy) of the vehicle, and the presence/absence of the obstacle around the vehicle. In such a way, the vehicle control according to the output of the vehicle-linked application can be carried out in a normal (safe) state of the vehicle.

### Embodiment 2

In Embodiment 2, when the user executes the vehicle-linked application that is operated by tapping on the touch panel in accordance with the tempo of the reproducing music, the travel state of the vehicle is controlled in accordance with the user operation to the output of the vehicle-linked application.

Note that the vehicle-mounted device and external device according to Embodiment 2 basically have the same components as those of Embodiment 1 described above, and thus when each of the components is denoted, it is to be referred to FIG. 1.

Next, an operation will be described.

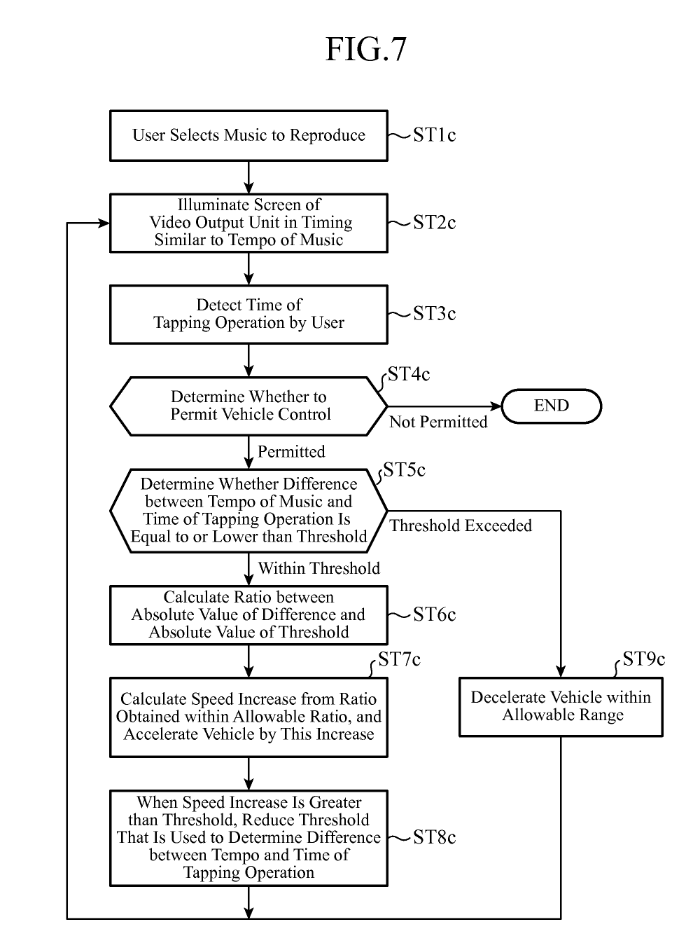

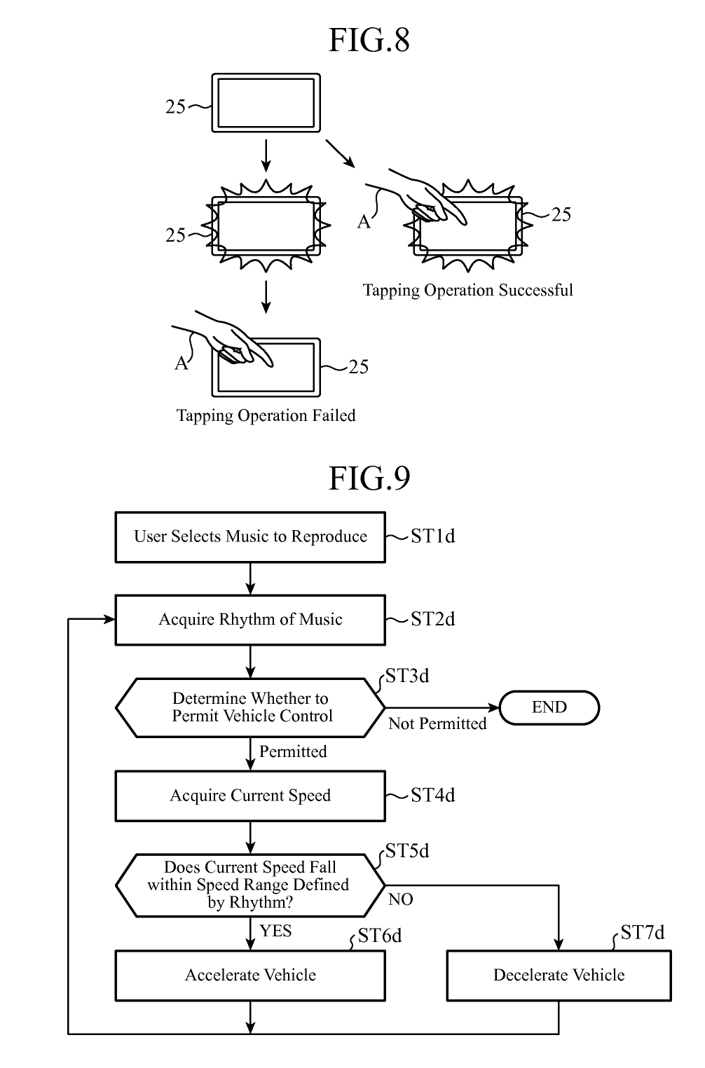

FIG. 7 is a flowchart showing a travel state control method according to Embodiment 2 of the present invention. In addition, FIG. 8 is a diagram showing an example of an output of a vehicle-linked application according to Embodiment 2 and a user operation thereto. In the following, there is described as an example a case in which the control unit 21 of the external device 2 executes the vehicle-linked application, and the vehicle-mounted device 1 instructs the vehicle control unit 3 to link the output of the vehicle-linked application with the travel state of the vehicle in accordance with a control signal from the external device 2. Note that as in Embodiment 1, the vehicle-mounted device 1 alone can perform the above processing.

First of all, using an input unit (not shown), the user selects the music to be reproduced in the sound output unit 24 (step ST1c).

The control unit 21 executes a music playback application as the vehicle-linked application, and illuminates the screen of the video output unit 25 in timing similar to the tempo of the music (step ST2c). Subsequently, the user A taps on the touch panel when the screen of the video output unit 25 is illuminated, as shown in FIG. 8.

The operation content determination unit 26 detects that time each time the user A executes the tapping operation, and outputs the detected time to the control unit 21 (step ST3c). At this time, the control unit 21 notifies the vehicle-mounted device 1 of a vehicle control request through the communication unit 20.

As in Embodiment 1, the control unit 11 of the vehicle-mounted device 1 determines whether to permit the vehicle control requested by the external device 2 (step ST4c). Here, in a case where the vehicle control is not permitted (step ST4c; not permitted), the processing is ended.

On the other hand, in a case where the vehicle control is permitted (step ST4c; permitted), the control unit 11 notifies the external device 2 of the permitted effect through the communication unit 10.

When the vehicle control is permitted, the control unit 21 of the external device 2 determines whether the difference between the time of the tapping operation by the user A that is input from the operation content determination unit 26, and the tempo of the music is within a predetermined threshold (step ST5c). Note that the threshold may be a predetermined fixed value or may be a value that can be set appropriately by the user A.

In a case where the difference between the time when the user A executed the tapping operation and the tempo of the music exceeds the threshold (step ST5c; threshold exceeded), the control unit 21 generates the control signal for decelerating the vehicle within a predetermined allowable range and transmits the control signal to the vehicle-mounted device 1 through the communication unit 20.

The control unit 11 of the vehicle-mounted device 1 instructs the vehicle control unit 3 to decelerate the vehicle in accordance with the above control signal received by the communication unit 10 (step ST9c). Note that the allowable range is, for example, a speed range that is defined beforehand with lower and upper limit speeds corresponding to a road type as references.

As mentioned above, when wishing to decelerate the vehicle, the user A can easily decelerate the vehicle by performing the tapping operation to increase the difference with the tempo of the music.

In a case where the difference between the time when the user A executed the tapping operation and the tempo of the music is within the threshold (step ST5c; within the threshold), the control unit 21 calculates the ratio between the above absolute value of the difference and the above absolute value of the threshold (step ST6c). Note that the ratio between the absolute value of the difference and the threshold represents the rate of deviation between the timing of the tapping operation and the tempo of the music. When the value of that ratio exceeds 1, it is considered that the tapping operation is failed.

Next, the control unit 21 calculates the increase in the speed from the value of the above ratio obtained within the above allowable range, generates the control signal for accelerating the vehicle by that increase, and transmits the control signal to the vehicle-mounted device 1 through the communication unit 20. The control unit 11 of the vehicle-mounted device 1 instructs the vehicle control unit 3 to accelerate the vehicle in accordance with the above control signal received by the communication unit 10 (step ST7c).

Here, the increase ΔV in the speed is calculated by, for example, the following equation (1), where Th is the absolute value of the above threshold, D is the above absolute value of the difference, and e is the maximum speed increase within the above allowable range.

ΔV=(1−D/Th)×e (1)

Subsequently, in a case where the speed increase calculated at step ST7c is greater than a predetermined threshold, the control unit 21 reduces by a predetermined amount the threshold that is used at step ST5c when the magnitude of the difference between the time of the tapping operation and the tempo of the music is determined (step ST8c). After this, the control unit 21 repeats the foregoing processing through return to step ST2c.

In the automatic operation mode, the speed of the vehicle is automatically set by the vehicle control; there are some cases in which the speed should be lower than the automatically set speed due to the relationship with other vehicles, while there are not many situations to be accelerated. In other words, accelerating the vehicle recklessly is not desirable to perform stable operation. Accordingly, the vehicle shall be accelerated under the condition that the timing of the tapping operation is matched with the tempo of the music, as described in step ST6c and step ST7c.

Further, when the vehicle is accelerated excessively, the condition for accelerating the vehicle is made strict by reducing the threshold that is used at step ST8c in the determination of the magnitude of the difference between the time of the tapping operation and the tempo of the music.

As described above, according to Embodiment 2, the control unit 21 (or 11) changes the travel state of the vehicle according to the timing of the user operation in accordance with the tempo of the music output by the vehicle-linked application. This configuration can help to easily change the travel state of the vehicle to a desired travel state according to the user operation.

### Embodiment 3

In Embodiment 3, the travel state of the vehicle is controlled in accordance with the rhythm of the reproducing music.

In addition, the vehicle-mounted device and external device according to Embodiment 2 basically have the same components as those of Embodiment 1 described above, and thus when each of the components is denoted, it is to be referred to FIG. 1.

Additionally, when the travel state of the vehicle is linked with the rhythm of the music, the user operation is not received, and thus, the operation content determination unit may be omitted in Embodiment 3.

Next, an operation will be described.

FIG. 9 is a flowchart showing a travel state control method according to Embodiment 3 of the present invention. In the following, there is described as an example a case in which the control unit 21 of the external device 2 executes a vehicle-linked application and the vehicle-mounted device 1 instructs the vehicle control unit 3 to link the output of the vehicle-linked application with the travel state of the vehicle in accordance with a control signal from the external device 2. Note that as in Embodiment 1, the vehicle-mounted device 1 alone can perform the above processing.

First of all, using an input unit (not shown), the user selects the music to be reproduced in the sound output unit 24 (step ST1d).

The control unit 21 executes a music playback application functioning as the vehicle-linked application, and acquires rhythm information on the music to be reproduced (step ST2d).

After this, the control unit 21 notifies the vehicle-mounted device 1 of a vehicle control request via the communication unit 20.

As in Embodiment 1, the control unit 11 of the vehicle-device 1 determines whether to permit the vehicle control requested by the external device 2 (step ST3d). Here, in a case where the vehicle control is not permitted (step ST3d; not permitted), the processing is ended.

On the other hand, in a case where the vehicle control is permitted (step ST4c; permitted), the control unit 11 notifies the external device 2 of the permitted effect through the communication unit 10. After this, when the vehicle control is permitted, the control unit 21 of the external device 2 requests the vehicle-mounted device 1 and receives the current speed of the vehicle that is acquired as the vehicle information by the vehicle information acquisition unit 14 (step ST4d).

Next, the control unit 21 determines whether the current speed of the vehicle falls within a speed range that is defined by the rhythm of the reproducing music (step ST5d).

Here, the above speed range is the range between the lower limit speed and upper limit speed of the vehicle defined beforehand for each music genre. For example, the speed range is set between 0 km/h and 40 km/h for ballad that has a rhythm slower than rock, and the speed range between 0 km/h and 60 km/h including a range faster than that of ballad is set for rock.

In a case where the current speed of the vehicle falls within the speed range defined beforehand by the rhythm of the music being reproduced (step ST5d; YES), the control unit 21 generates the control signal for accelerating the vehicle by a predetermined speed increase, and transmits the control signal to the vehicle-mounted device 1 through the communication unit 20.

The control unit 11 of the vehicle-mounted device 1 instructs the vehicle control unit 3 to accelerate the vehicle in accordance with the control signal received by the communication unit 10 (step ST6d).

On the other hand, in a case where the current speed of the vehicle does not fall within the speed range defined by the rhythm of the music being reproduced (step ST5d; NO), the control unit 21 generates the control signal for decelerating the vehicle by a predetermined speed decrease, and transmits the control signal to the vehicle-mounted device 1 through the communication unit 20.

The control unit 11 of the vehicle-mounted device 1 instructs the vehicle control unit 3 to decelerate the vehicle in accordance with the above control signal received by the communication unit 10 (step ST7d).

As described above, according to Embodiment 3, the control unit 21 (or 11) links the rhythm of the music output by the vehicle-linked application with the travel state of the vehicle. This also allows the user to intuitively grasp the travel state of the vehicle, and easily change the travel state to a desired travel state when the user selects a music of a desired genre (rhythm).

### Embodiment 4

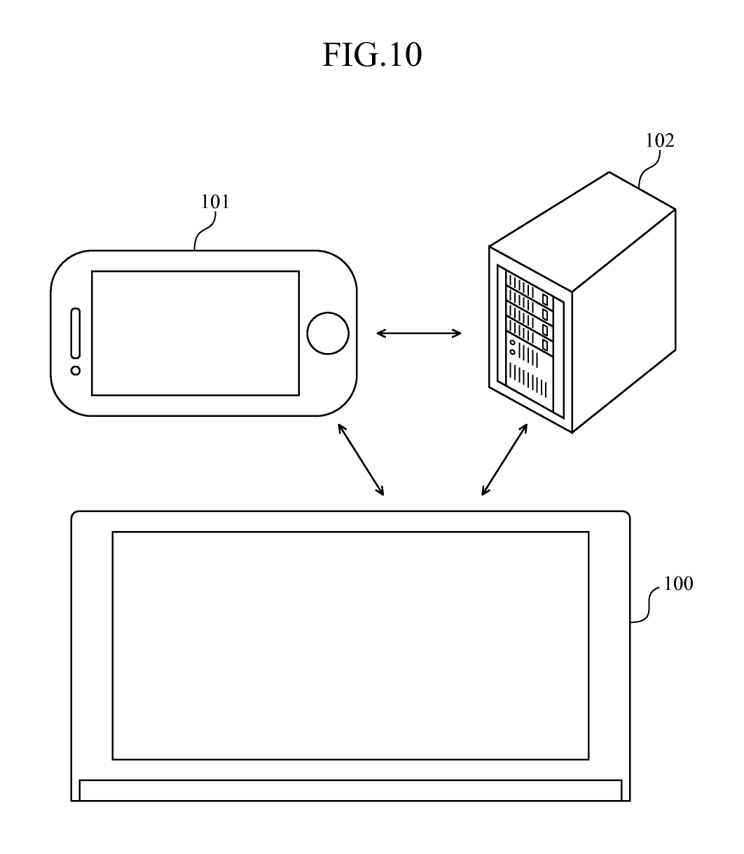

FIG. 10 is a diagram showing a configuration of a travel state control system according to Embodiment 4 of the present invention. In the travel state control system shown in FIG. 10, a vehicle-mounted device 100 cooperates with a portable terminal 101 and a server device 102 to control the travel state of a vehicle. Hereinafter, an aspect of the configuration of the travel state control system will be described.

There is first described a case in which the vehicle-mounted device 100 functions as a device for controlling the travel state of the vehicle in cooperation with the server device 102.

In the configuration, the following case is conceived: the vehicle-mounted device 100 is in direct communication with the server device 102, or communicates with the server device 102 through the portable terminal 101.

The server device 102 has the data storage unit 22, the program storage unit 23, and the control unit 11 described in Embodiment 1, in addition to a communication unit performing the communication described above.

In other words, the control unit 11 of the server device 102 executes a vehicle-linked application accompanied by at least one of a visual output and an auditory output, and the foregoing communication unit of the server device 102 transmits to the vehicle-mounted device 100 the output content that is obtained as a result of the execution of the vehicle-linked application.

The vehicle-mounted device 100 is configured with the communication unit 10, vehicle information acquisition unit 14, operation content determination unit 15, sound output unit 16, and video output unit 17 that are described in Embodiment 1.

Here, the communication unit 10 directly communicates with the server device 102, or becomes a communication unit for communicating with the server device 102 through the portable terminal 101.

As in Embodiment 1, the operation content determination unit 15 determines the content of a user operation to the output of the vehicle-linked application. Additionally, when the travel state of the vehicle is controlled in accordance with the output content of the vehicle-linked application, the operation content determination unit 15 may be omitted.

The sound output unit 16 and the video output unit 17 present to the user the output content of the vehicle-linked application that is received from the server device 102 by the communication unit 10.

As in Embodiment 1, the vehicle information acquisition unit 14 acquires vehicle information on the state of the vehicle equipped with the vehicle-mounted device 100.

When communication and connection is established between the vehicle-mounted device 100 and the server device 102, the vehicle information acquisition unit 14 of the vehicle-mounted device 100 transmits the vehicle information to the server device 102 through the communication unit 10.

The control unit 11 of the server device 102 executes the vehicle-linked application, transmits the output content of the vehicle-linked application to the vehicle-mounted device 100 through the above communication unit, and transmits to the vehicle-mounted device 100 a control signal for linking the output content of the vehicle-linked application with the travel state of the vehicle based on the vehicle information received from the vehicle-mounted device 100.

In the vehicle-mounted device 100, the sound output unit 16 and the video output unit 17 present to the user the output content of the vehicle-linked application that is received from the server device 102 by the communication unit 10, and instruct the vehicle control unit 3 to link the output content of the vehicle-linked application with the travel state of the vehicle in accordance with the above control signal.

In the vehicle-mounted device 100, in a case where a user operation is performed to the output of the vehicle-linked application, the operation content determination unit 15 of determines the content of that operation. The determination result is transmitted to the server device 102 via the communication unit 10. In accordance with the content of the user operation received from the vehicle-mounted device 100, the control unit 11 of the server device 102 generates the control signal for changing the output of the vehicle-linked application and the travel state of the vehicle in linkage with each other, and returns the control signal to the vehicle-mounted device 100. In this manner, in the vehicle-mounted device 100, the vehicle control unit 3 can be instructed to change the output of the vehicle-linked application and the travel state of the vehicle in linkage with each other in accordance with the content of the user operation.

Next, there is described a case in which the vehicle-mounted device 100 cooperates with the portable terminal 101 and the server device 102 to function as a device for controlling the travel state of the vehicle.

In the configuration, it is conceived that the vehicle-mounted device 100 communicates with the portable terminal 101.

As with the above, the vehicle-mounted device 100 is configured with the communication unit 10, vehicle information acquisition unit 14, operation content determination unit 15, sound output unit 16, and video output unit 17.

As with the external device 2 described in Embodiment 1, the portable terminal 101 has the communication unit 20 for communicating with the vehicle-mounted device 100, control unit 21, data storage unit 22, program storage unit 23, sound output unit 24, video output unit 25, and operation content determination unit 26, but does not have the vehicle-linked application.

The server device 102 is configured with a communication unit for communicating with the portable terminal 101, and a database for storing and managing the vehicle-linked application.

When communication and connection is established between the vehicle-mounted device 100 and the server device 102, the portable terminal 101 receives the vehicle information acquired by the vehicle information acquisition unit 14 of the vehicle-mounted device 100 through the communication unit 20, and receives the vehicle-linked application from the server device 102.

The control unit 21 of the portable terminal 101 executes the vehicle-linked application, and either presents to the user the output content of the vehicle-linked application by means of the sound output unit 24 and the video output unit 25 or transmits the output content of the vehicle-linked application to the vehicle-mounted device 100 through the communication unit 20.

Further, the control unit 21 of the portable terminal 101 transmits to the vehicle-mounted device 100 the control signal for linking the output content of the vehicle-linked application with the travel state of the vehicle based on the vehicle information received from the vehicle-mounted device 100. In accordance with the control signal from the portable terminal 101, the vehicle-mounted device 100 instructs the vehicle control unit 3 to link the output content of the vehicle-linked application with the travel state of the vehicle.

In the vehicle-mounted device 100, in a case where the user operation is performed to the output of the vehicle-linked application, the operation content determination unit 15 determines the content of that operation. The determination result is transmitted to the portable terminal 101 via the communication unit 10.

In addition, in the portable terminal 101, in a case where the user operation is performed to the output of the vehicle-linked application, the operation content determination unit 26 determines the content of that operation.

According to the content of the user operation determined as described above, the control unit 21 of the portable terminal 101 generates a control signal for changing the output of the vehicle-linked application and the travel state of the vehicle in linkage with each other, and returns the control signal to the vehicle-mounted device 100. In this manner, in the vehicle-mounted device 100, the vehicle control unit 3 can be instructed to change the output of the vehicle-linked application and the travel state of the vehicle in linkage with each other in accordance with the content of the user operation.

As described above, according to Embodiment 4, the server device 102 has the communication unit that receives the vehicle information on the state of the vehicle from the vehicle-mounted device 100, and the control unit 11 that executes the vehicle-linked application accompanied by at least one of a visual output and an auditory output and, based on the vehicle information that is received from the vehicle-mounted device 100 by the communication unit, instructs the vehicle control unit 3 that controls the travel state of the vehicle to link the output content of the vehicle-linked application with the travel state of the vehicle. This configuration can help to intuitively grasp the travel state of the vehicle and easily change the travel state to a desired travel state.

Furthermore, according to Embodiment 4, a travel state control method for the portable terminal 101 has a step in which the communication unit 20 receives the vehicle information on the state of the vehicle from the vehicle-mounted device 100, and a step in which the control unit 21 executes the vehicle-linked application accompanied by at least one of the visual output and auditory output and, based on the vehicle information that is received from the vehicle-mounted device 100 by the communication unit 20, instructs the vehicle control unit 3 that controls the travel state of the vehicle to link the output content of the vehicle-linked application with the travel state of the vehicle. This configuration also can help to intuitively grasp the travel state of the vehicle and easily change the travel state to a desired travel state.

It is noted that in the present invention, a free combination in the embodiments, a modification of arbitrary components in the embodiments, or an omission of arbitrary components in the embodiments is possible within a range of the invention.

### INDUSTRIAL APPLICABILITY

Since the vehicle-mounted device of the present invention enables the user to intuitively grasp the travel state of the vehicle and easily change the travel state of the vehicle to a desired travel state, it is suitable for, for example, a media reproducer that is equipped in a vehicle having an automatic operation mode in which the vehicle is operated automatically.

### DESCRIPTION OF REFERENCE NUMERALS AND SIGNS

1, 100: Vehicle-mounted device
2: External device
3: Vehicle control unit
10, 20: Communication unit
11, 21: Control unit
12, 22: Data storage unit
13, 23: Program storage unit
14: Vehicle information acquisition unit
15, 26: Operation content determination unit
16, 24: Sound output unit
17, 25: Video output unit
101: Portable terminal
102: Server device.

1. A vehicle-mounted device, comprising:
a vehicle information acquirer that acquires vehicle information on a state of a vehicle; and
a controller that executes an application accompanied by at least one of a visual output and an auditory output, and that based on the vehicle information acquired by the vehicle information acquirer, instructs a vehicle controller that controls a travel state of the vehicle to link an output content of the application with the travel state of the vehicle.

2. The vehicle-mounted device according to claim 1, further comprising:
an operation content determinator that determines a content of an operation to the output of the application,
wherein the controller changes the output content of the application and the travel state of the vehicle in linkage with each other in accordance with the content of the operation determined by the operation content determinator.

3. The vehicle-mounted device according to claim 1, wherein the controller links a movement of a character displayed by the application with the travel state of the vehicle.

4. The vehicle-mounted device according to claim 1, wherein the controller links a rhythm of music output by the application with the travel state of the vehicle.

5. The vehicle-mounted device according to claim 1, wherein the controller determines whether to link the output of the application with the travel state of the vehicle, based on at least one of a type of a road on which the vehicle travels, a remaining amount of driving energy of the vehicle, and presence/absence of an obstacle around the vehicle.

6. The vehicle-mounted device according to claim 1, wherein the controller changes the travel state of the vehicle according to timing of a user operation matched with a tempo of music output by the application.

7. A server controlling a travel state of a vehicle equipped with a vehicle-mounted device, comprising:
a communicator that receives vehicle information on a state of the vehicle from the vehicle-mounted device; and
a controller that executes an application accompanied by at least one of a visual output and an auditory output and that based on the vehicle information received from the vehicle-mounted device by the communicator, instructing a vehicle controller that controls the travel state of the vehicle to link an output content of the application with the travel state of the vehicle.

8. A travel state control method controlling a travel state of a vehicle equipped with a vehicle-mounted device, comprising:
a step in which a communicator receives vehicle information on a state of the vehicle from the vehicle-mounted device; and
a step in which a controller executes an application accompanied by at least one of a visual output and an auditory output and based on the vehicle information received from the vehicle-mounted device by the communicator, instructs a vehicle controller that controls the travel state of the vehicle to link an output content of the application with the travel state of the vehicle.
